(19) United States
(12) Patent Application Publication
(10) Pub. No.: US 2016/0362951 A1
(43) Pub. Date: Dec. 15, 2016

(54) ASSESSMENT AND CONTROL OF DRILLING FLUID CONDITIONING SYSTEM

(71) Applicant: HALLIBURTON ENERGY SERVICES, INC., Houston, TX (US)

(72) Inventors: Xiangnan Ye, Cypress, TX (US); Katerina V. Newman, Houston, TX (US); Dale E. Jamison, Humble, TX (US); Cato Russell McDaniel, The Woodlands, TX (US); Timothy N. Harvey, Humble, TX (US)

(21) Appl. No.: 15/120,997

(22) PCT Filed: Jun. 12, 2014
(86) PCT No.: PCT/US2014/042181

§ 371 Date: Aug. 23, 2016

(51) Int. Cl. E21B 21/06; G01N 25/18; E21B 47/06

(52) U.S. Cl. CPC E21B 21/06; E21B 47/065; G01N 25/18

(57) ABSTRACT

A drilling fluid conditioning system can include at least one drilling fluid conditioning device, and at least one heat transfer property sensor that outputs real time measurements of a heat transfer property of a drilling fluid that flows through the drilling fluid conditioning device. A method can include measuring a heat transfer property of a drilling fluid, and determining, based on the measured heat transfer property, an oil to water ratio of the drilling fluid. A well system can include a drilling fluid that circulates through a wellbore and a drilling fluid conditioning system, and the drilling fluid conditioning system including at least one drilling fluid conditioning device, and at least one thermal conductivity sensor that measures a thermal conductivity of the drilling fluid.

### TECHNICAL FIELD

This disclosure relates generally to equipment utilized and operations performed in conjunction with subterranean wells and, in one example described below, more particularly provides for assessment and control of a drilling fluid conditioning system.

### BACKGROUND

An oil/water ratio and a solids concentration of a drilling fluid can affect the drilling fluid's properties, integrity, ability to perform required functions, for example, lubricate and cool a drill bit, mitigate formation pressure, prevent fluid loss and enhance wellbore stability. Thus, it will be appreciated that improvements are continually needed in the art of assessing and controlling drilling fluid conditioning systems.

### BRIEF DESCRIPTION OF THE DRAWINGS

FIG. 1 is a representative partially cross-sectional view of a well system and associated method which can embody principles of this disclosure.

FIG. 2 is a representative graph of thermal conductivity versus water/oil ratio for a water based emulsion.

FIG. 3 is a representative graph of thermal conductivity versus water/oil ratio for an oil based emulsion.

FIG. 4 is a representative graph of thermal conductivity versus solids concentration in a drilling fluid.

FIG. 5 is a representative flow chart for an example of the method.

### DETAILED DESCRIPTION

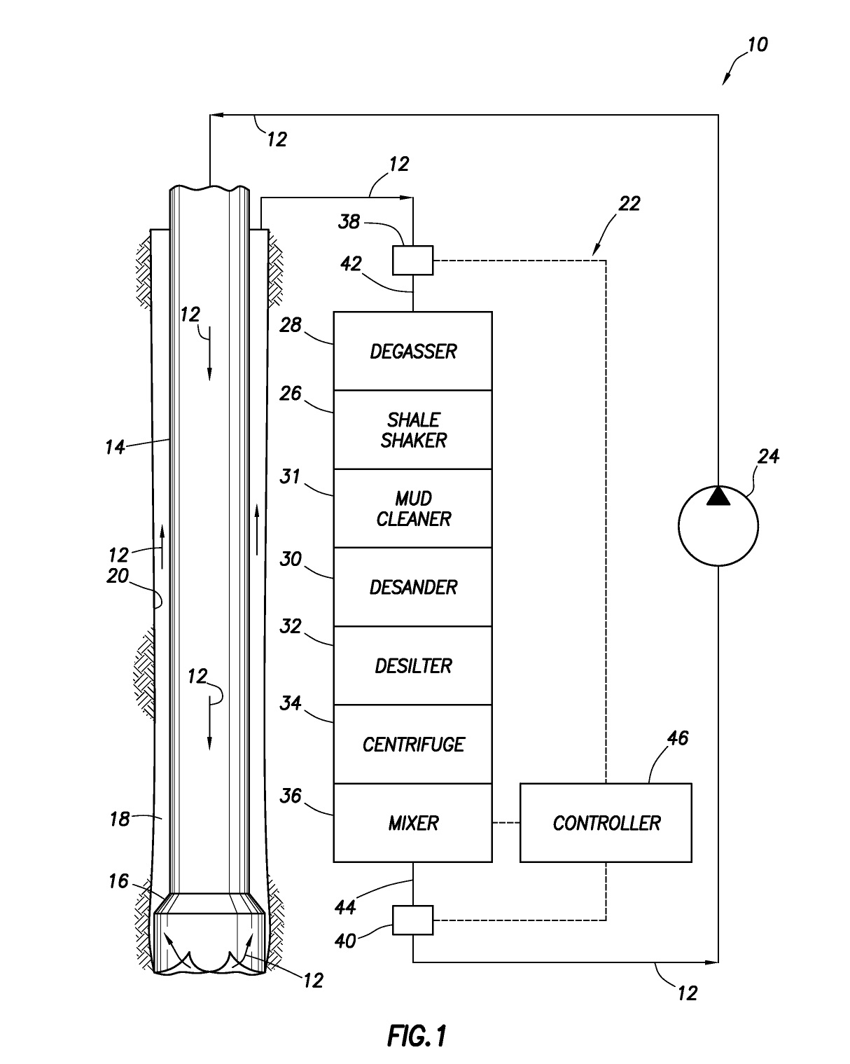

Representatively illustrated in FIG. 1 is a system 10 for use with a well, and an associated method, which system and method can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a drilling fluid 12 (also known to those skilled in the art as drilling “mud”) is circulated through a drill string 14, out of a drill bit 16 at a distal end of the drill string, and back to the earth's surface via an annulus 18 between the drill string and a wellbore 20. The drilling fluid 12 is conditioned at the surface by a drilling fluid conditioning system 22 prior to being pumped back into the drill string 14 by a rig mud pump 24.

As used herein, the term “earth's surface” is used to indicate a location at or near a surface of the earth. The earth's surface can be on land or on water. A drilling fluid conditioning system will be at the earth's surface, for example, if it is on a floating or fixed offshore rig, or at a land rig.

The drilling fluid conditioning system 22 depicted in FIG. 1 includes several drilling fluid conditioning devices, namely, a shale shaker 26, a degasser 28, a desander 30, a mud cleaner 31, a desilter 32, a centrifuge 34 and a mixer 36. More, fewer, other or different drilling fluid conditioning devices may be included in the system 22, if desired. Thus, the scope of this disclosure is not limited to any particular configuration, arrangement, number or combination of drilling fluid conditioning devices in the system 22.

The shale shaker 26, desander 30, mud cleaner 31, desilter 32 and centrifuge 34 remove progressively finer drill cuttings, sand, formation fines and other substances from the drilling fluid 12. The degasser 28 removes entrained gas from the drilling fluid 12. The mixer 36 is used to add weighting materials, fluid loss control agents, chemicals and other substances to the drilling fluid 12 as needed, prior to the drilling fluid being pumped into the drill string 14 by the pump 24.

In the FIG. 1 example, the drilling fluid conditioning system 22 further includes thermal conductivity sensors 38, 40 connected at an input 42 and an output 44, respectively, of the system. In other examples, a thermal conductivity sensor could be connected between, or integrated as part of, any of the drilling fluid conditioning devices 26, 28, 30, 31, 32, 34, 36. One or multiple thermal conductivity sensors may be used in the system 22. Thus, the scope of this disclosure is not limited to any particular number, location (or combination of locations) of thermal conductivity sensors in the system 22.

Any suitable thermal conductivity sensor may be used in the system 22. Typically, a thermal conductivity sensor will include a heating element and a temperature sensor for detecting a temperature of a heated substance. However, other types of thermal conductivity sensors may be used, if desired.

The thermal conductivity sensors 38, 40 provide real time measurements of the thermal conductivity of the drilling fluid 12, thereby enabling important decisions about how to manage properties of the drilling fluid 12 to be made quickly. If, for example, the oil to water ratio or solids concentration of the drilling fluid 12 is not within a desired range, adjustments can be made in the drilling fluid conditioning system 22.

The term “thermal conductivity” is used herein to indicate a heat transfer property of a drilling fluid. Other heat transfer properties that could be measured by the sensors 38, 40 include thermal inertia, thermal effusivity and thermal diffusivity. Thus, the scope of this disclosure is not limited to measurement of only thermal conductivity of a drilling fluid. Thermal conductivity is merely one example of a heat transfer property that could be measured, evaluated, controlled, etc., using the principles of this disclosure.

As used herein, the term “real time” is used to indicate immediate performance of an activity. An activity is considered to be performed in real time if the activity is instantaneous or takes no more than a few seconds to perform. An activity that takes many minutes, or an hour or more to perform, is not considered to be performed in real time.

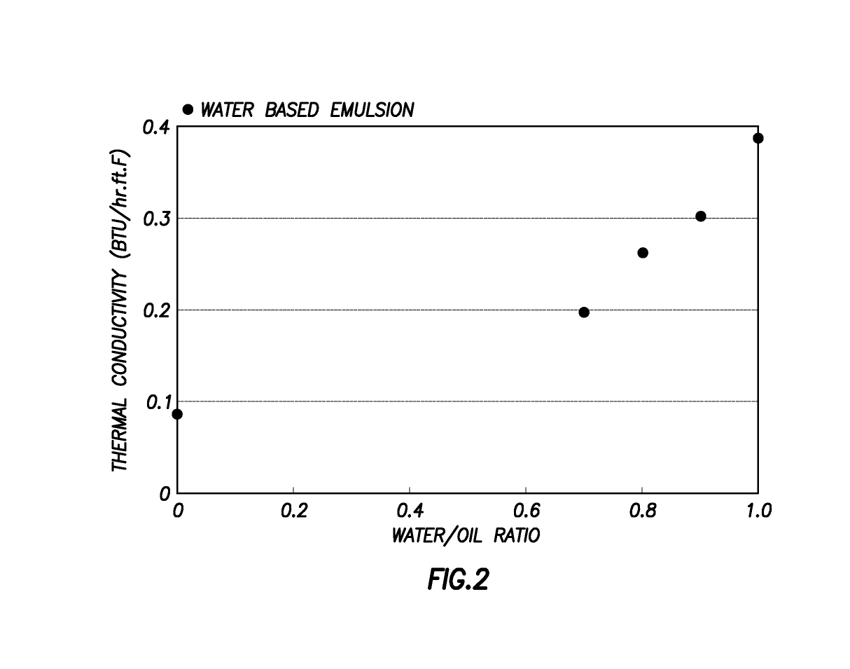

Thermal conductivity and other heat transfer properties of the drilling fluid 12 are related to its oil to water ratio. For particular drilling fluid types, if the thermal conductivity of the drilling fluid is known, the oil to water ratio can be readily determined, as demonstrated by the example graphs of FIGS. 2 & 3.

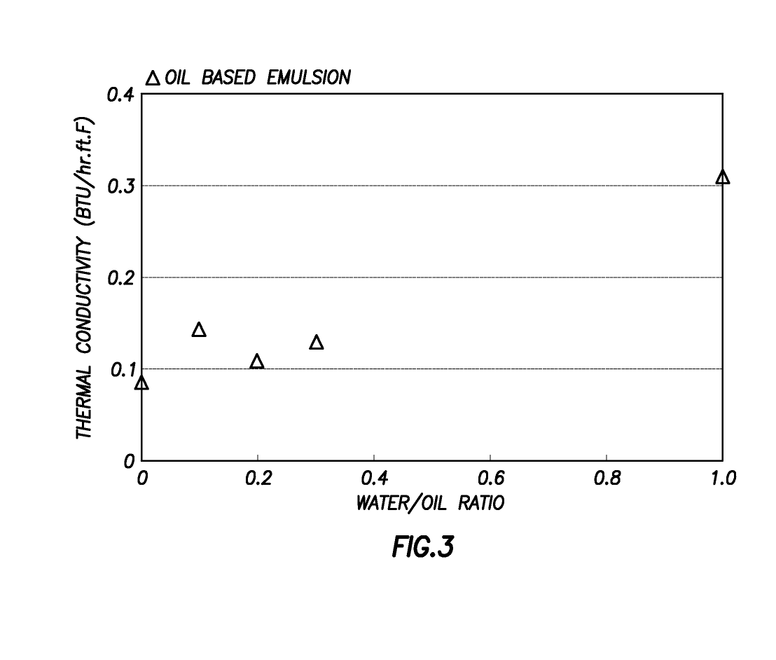

FIG. 2 is a representative graph of thermal conductivity versus water/oil ratio for an example water based emulsion. FIG. 3 is a representative graph of thermal conductivity versus water/oil ratio for an example oil based emulsion.

The FIGS. 2 & 3 graphs were experimentally derived. Similar graphs can be experimentally derived for various types of drilling fluids (for example, oil-based muds, synthetic-based muds and water-based muds).

Curve-fitting techniques can be used to generate equations from the experimental data for relating thermal conductivity to oil to water ratio for particular drilling fluid types, or the experimental data can be stored in lookup tables, for example, for use in interpolation between experimental data points. Any suitable technique, or combination of techniques, may be used to relate thermal conductivity to oil to water ratio for particular drilling fluid types.

As used herein, the term “oil to water ratio” is used to indicate a ratio of oil and water volumes in a fluid composition. The term “oil to water ratio” encompasses alternate expressions, as well. For example, an oil to water ratio may be alternatively expressed as a water to oil ratio, a water volume fraction, or an oil volume fraction.

Referring again to FIG. 1, a controller 46 is included in the system 22 for controlling operation of one of the drilling fluid conditioning devices 26, 28, 30, 31, 32, 34, 36. In this example, the controller 46 controls operation of the mixer 36, but in other examples the controller could control operation of one or any combination of the drilling fluid conditioning devices.

The controller 46 could, for example, be a PID (proportional integral differential) controller of the type that can control operation of a device as needed to influence a measured value toward a desired value or range. However, the scope of this disclosure is not limited to use of any particular type of controller. In some examples, control of operation of one or more of the drilling fluid conditioning devices 26, 28, 30, 31, 32, 34, 36 may be manually performed, based on the oil to water ratios determined from the thermal conductivity measurements.

In the FIG. 1 example, the controller 46 determines a difference between the oil to water ratio of the drilling fluid 12 (as determined from the thermal conductivity measurement(s)) and a desired oil to water ratio set point (the set point could be a desired oil to water ratio or range of ratios). If the determined oil to water ratio deviates from the desired oil to water ratio set point, the controller 46 will adjust operation of the mixer 36 (for example, varying an amount of water, chemical, weighting material or other substance added to the drilling fluid 12 in the mixer) as needed to influence the oil to water ratio toward the desired set point.

The use of thermal conductivity sensors 38, 40 at both the input 42 and output 44 of the drilling fluid conditioning system 22 allows for an evaluation of how the drilling fluid conditioning system changes the thermal conductivity and oil to water ratio of the drilling fluid 12. However, it is not necessary for thermal conductivity sensors 38, 40 to be connected at both the input 42 and output 44 of the system 22 in keeping with the principles of this disclosure.

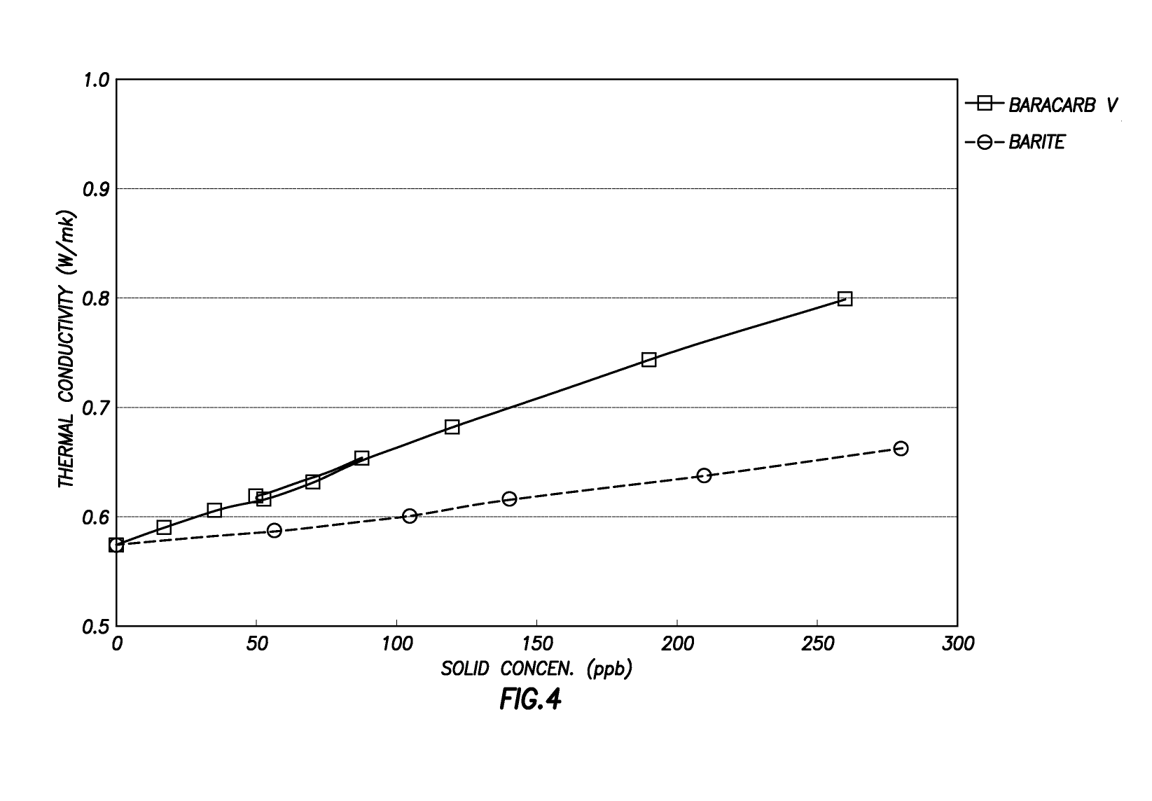

FIG. 4 is a representative graph of thermal conductivity versus solids concentration for two conventional types of solids mixed in drilling fluids. One of the solids is barite, and the other is a proprietary fluid loss control agent BARACARB™ 5 available from Halliburton Energy Services, Inc. of Houston, Tex. USA.

The FIG. 4 graph resulted from experiments conducted by the present inventors. The graph indicates that thermal conductivity of a drilling fluid is strongly correlated to concentrations of solids therein and, thus, that solids concentrations can be evaluated by measuring the thermal conductivity of the drilling fluid.

For use in controlling operation of the mixer 36 in the drilling fluid conditioning system 22 of FIG. 1, the drilling fluid 12 thermal conductivity (for example, as measured by the sensor 40) can be used to determine whether a solids concentration of the drilling fluid has increased or decreased, or whether the solids concentration is too high or too low.

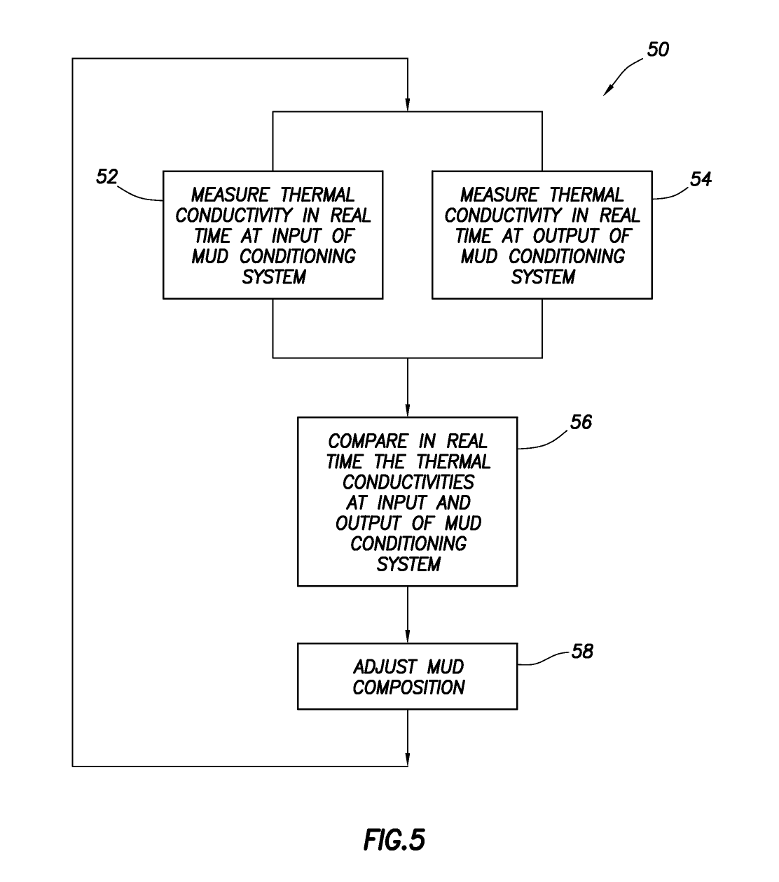

FIG. 5 is a representative flow chart for an example of a method 50 of controlling the oil to water ratio of the drilling fluid 12. The method 50 may be performed with the well system 10 of FIG. 1, or it may be performed with other well systems.

In steps 52 and 54 of the method 50, the thermal conductivity of the drilling fluid 12 is measured in real time at the input 42 and at the output 44 of the drilling fluid conditioning system 22. However, as discussed above, the scope of this disclosure is not limited to use of multiple thermal conductivity sensors 38, 40, or to use of thermal conductivity sensors at any particular location in the drilling fluid conditioning system 22. It is also not necessary for the thermal conductivity measurements to be performed in real time.

In step 56, the thermal conductivities of the drilling fluid 12 at the input 42 and output 44 of the system 22 are compared. This comparison can yield valuable information as to an efficiency, effectiveness, etc., of any change in thermal conductivity, oil to water ratio and/or solids concentration caused by the system 22. Operation of any of the drilling fluid conditioning devices 26, 28, 30, 31, 32, 34, 36 may be changed, based on the comparison made in step 56.

In step 58, a composition of the drilling fluid 12 is adjusted, based on the thermal conductivity measurements. For example, if the thermal conductivity measurements indicate that an oil to water ratio and/or a solids concentration of the drilling fluid 12 deviates from a desired oil to water ratio and/or solids concentration, then operation of any of the drilling fluid conditioning devices 26, 28, 30, 31, 32, 34, 36 can be changed as needed to influence the drilling fluid oil to water ratio and/or solids concentration toward the desired oil to water ratio and/or solids concentration. In the system 22 example of FIG. 1, the controller 46 can control operation of the mixer 36 as needed to maintain the desired oil to water ratio and/or solids concentration of the drilling fluid 12.

Note that it is not necessary for the measured thermal conductivity of the drilling fluid 12 to be converted to an oil to water ratio and/or solids concentration in order to control operation of the system 22 so that a desired oil to water ratio and/or solids concentration can be maintained. Instead, the desired oil to water ratio and/or solids concentration could be converted to a desired thermal conductivity (including a desired range of thermal conductivities) for the particular drilling fluid 12, and the controller 46 could be used to control operation of the system 22 so that the desired thermal conductivity is maintained.

It may now be fully appreciated that the above disclosure provides significant advancements to the art of determining and controlling an oil to water ratio, solids concentration or other parameter of a drilling fluid. In some examples described above, the oil to water ratio, solids concentration or other parameter can be determined and controlled in real time by measuring a thermal conductivity of the drilling fluid 12 in a drilling fluid conditioning system 22.

The above disclosure provides to the art a drilling fluid conditioning system 22 that, in one example, includes at least one drilling fluid conditioning device 26, 28, 30, 31, 32, 34, 36; and at least one heat transfer property sensor 38, 40 that outputs real time measurements of a heat transfer property of a drilling fluid 12 that flows through the drilling fluid conditioning device 26, 28, 30, 31, 32, 34, 36.

The heat transfer property sensor 38, 40 may be connected at an input 42 to the drilling fluid conditioning system 22, and/or at an output 44 of the drilling fluid conditioning system 22.

The “at least one” heat transfer property sensor can comprise first and second heat transfer property sensors 38, 40. The first heat transfer property sensor 38 can measure the heat transfer property of the drilling fluid 12 at an input 42 to the drilling fluid conditioning system 22, and the second heat transfer property sensor 40 can measure the heat transfer property of the drilling fluid 12 at an output 44 of the drilling fluid conditioning system 22.

The “at least one” drilling fluid conditioning device may comprise multiple drilling fluid conditioning devices 26, 28, 30, 31, 32, 34, 36, and the heat transfer property sensor (38 or 40) may be connected between the drilling fluid conditioning devices. The heat transfer property sensor (38 or 40) may be connected between a rig mud pump 24 and an output 44 of the drilling fluid conditioning system 22.

The drilling fluid conditioning system 22 may also include a controller 46 that adjusts an oil to water ratio or solids concentration of the drilling fluid 12 in response to the measurements of the heat transfer property of the drilling fluid 12.

A method 50 is also provided to the art by the above disclosure. In one example, the method 50 can comprise measuring a heat transfer property of a drilling fluid 12; and determining, based on the measured heat transfer property, a parameter of the drilling fluid 12, the parameter being selected from the group consisting of oil to water ratio and solids concentration.

The measuring step can be performed at a drilling fluid conditioning system 22 proximate a surface of the earth. The measuring step may be performed at one or more of an input 42 to the drilling fluid conditioning system 22, an output 44 from the drilling fluid conditioning system 22 and between drilling fluid conditioning devices 26, 28, 30, 31, 32, 34, 36.

The method 50 can also include comparing heat transfer property measurements performed at the input 42 and the output 44 of the drilling fluid conditioning system 22.

The method 50 can include adjusting the oil to water ratio or solids concentration of the drilling fluid 12 in response to the determining step.

The method 50 can include controlling a drilling fluid conditioning device 26, 28, 30, 31, 32, 34, 36 in response to the determined oil to water ratio or solids concentration.

The measuring step can include outputting the heat transfer property in real time.

Also described above is a well system 10 comprising a drilling fluid 12 that circulates through a wellbore 20 and a drilling fluid conditioning system 22. The drilling fluid conditioning system 22 comprises at least one drilling fluid conditioning device 26, 28, 30, 31, 32, 34, 36, and at least one thermal conductivity sensor 38, 40 that measures a thermal conductivity of the drilling fluid 12.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A drilling fluid conditioning system, comprising:
at least one drilling fluid conditioning device; and
at least one heat transfer property sensor that outputs real time measurements of a heat transfer property of a drilling fluid that flows through the drilling fluid conditioning device.

2. The drilling fluid conditioning system of claim 1, wherein the heat transfer property sensor is connected at an input to the drilling fluid conditioning system.

3. The drilling fluid conditioning system of claim 1, wherein the heat transfer property sensor is connected at an output of the drilling fluid conditioning system.

4. The drilling fluid conditioning system of claim 1, wherein the at least one heat transfer property sensor comprises first and second heat transfer property sensors, wherein the first heat transfer property sensor measures the heat transfer property of the drilling fluid at an input to the drilling fluid conditioning system, and wherein the second heat transfer property sensor measures the heat transfer property of the drilling fluid at an output of the drilling fluid conditioning system.

5. The drilling fluid conditioning system of claim 1, wherein the at least one drilling fluid conditioning device comprises first and second drilling fluid conditioning devices, and wherein the heat transfer property sensor is connected between the first and second drilling fluid conditioning devices.

6. The drilling fluid conditioning system of claim 1, wherein the heat transfer property sensor is connected between a rig mud pump and an output of the drilling fluid conditioning system.

7. The drilling fluid conditioning system of claim 1, further comprising a controller that adjusts a parameter of the drilling fluid in response to the measurements of the heat transfer property of the drilling fluid, the parameter being selected from the group consisting of oil to water ratio and solids concentration.

8. A method, comprising:
measuring a heat transfer property of a drilling fluid; and
determining, based on the measured heat transfer property, a parameter of the drilling fluid, the parameter being selected from the group consisting of oil to water ratio and solids concentration.

9. The method of claim 8, wherein the measuring is performed at a drilling fluid conditioning system proximate a surface of the earth.

10. The method of claim 9, wherein the measuring is performed at a selected one or more of the group consisting of an input to the drilling fluid conditioning system, an output from the drilling fluid conditioning system and between drilling fluid conditioning devices.

11. The method of claim 10, further comprising comparing heat transfer property measurements performed at the input and the output of the drilling fluid conditioning system.

12. The method of claim 8, further comprising adjusting the parameter of the drilling fluid in response to the determining.

13. The method of claim 8, further comprising controlling a drilling fluid conditioning device in response to the determined parameter.

14. The method of claim 8, wherein the measuring further comprises outputting the heat transfer property in real time.

15. A well system, comprising:
a drilling fluid that circulates through a wellbore and a drilling fluid conditioning system, and
wherein the drilling fluid conditioning system comprises at least one drilling fluid conditioning device, and at least one thermal conductivity sensor that measures a thermal conductivity of the drilling fluid.

16. The well system of claim 15, wherein the thermal conductivity sensor is connected at a selected one or more of the group consisting of an input to the drilling fluid conditioning system and an output of the drilling fluid conditioning system.

17. The well system of claim 15, wherein the at least one thermal conductivity sensor comprises first and second thermal conductivity sensors, wherein the first thermal conductivity sensor measures the thermal conductivity of the drilling fluid at an input to the drilling fluid conditioning system, and wherein the second thermal conductivity sensor measures the thermal conductivity of the drilling fluid at an output of the drilling fluid conditioning system.

18. The well system of claim 15, wherein the at least one drilling fluid conditioning device comprises first and second drilling fluid conditioning devices, and wherein the thermal conductivity sensor is connected between the first and second drilling fluid conditioning devices.

19. The well system of claim 15, wherein the thermal conductivity sensor is connected between a rig mud pump and an output of the drilling fluid conditioning system.

20. The well system of claim 15, wherein the drilling fluid conditioning system further comprises a controller that adjusts a parameter of the drilling fluid in response to the measurements of the thermal conductivity of the drilling fluid.
